(19) United States
(12) Patent Application Publication
(10) Pub. No.: US 2001/0042779 A1
(43) Pub. Date: Nov. 22, 2001

(54) Solder paste

(76) Inventors: Hitoshi Amita, Chiba (JP); Noriko Murase, Chiba (JP); Takashi Shoji, Chiba (JP)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/776,662

(22) Filed: Feb. 6, 2001

Related U.S. Application Data
(60) Provisional application No. 60/246,730, filed on Nov. 9, 2000.

(30) Foreign Application Priority Data
Feb. 8, 2000 (JP) P2000-035661
Jul. 26, 2000 (JP) P2000-224866

(51) Int. Cl. B23K 35/36; B23K 31/02; B23K 31/00

(52) U.S. Cl. 228/224; 228/248.1

(57) ABSTRACT

To provide a solder paste having excellent storage stability; a method for soldering, which method is highly reliable and suitable for producing fine-pitch mounted wiring boards and a variety of parts; and a joint produced through soldering.

The halide ion concentration in one gram of flux contained in a solder paste containing a halogen compound is controlled to 3000 ppm or less as converted to chloride ion concentration.

### CROSS REFERENCE TO RELATED APPLICATION

The present application is filed under 35 U.S.C. §111(a), and claims benefit, pursuant to 35 U.S.C. §119(e)(1), of the filing date of Provisional Application No. 60/246,730 filed Nov. 9, 2000 pursuant to 35 U.S.C. §111(b).

### FIELD OF THE INVENTION

The present invention relates to a solder paste employed for mounting electronic parts on a substrate surface, and more particularly, to such a solder paste having excellent storage stability. The invention also relates to a soldering method utilizing the solder paste and to a joint produced through the method.

### BACKGROUND ART

In the electronics industry, solder paste is employed for mounting electronic parts on a substrate surface. Solder paste, having suitable coatability for printing and suitable viscosity, is suited for automatic application thereof. Thus, in recent years, the amount of solder paste employed in the industry has increased more and more.

In the electronics industry, electronic parts are mounted in such a manner that a solder paste is applied to a printed circuit substrate through screen printing or by means of a dispenser; electronic parts are placed on the solder paste; and the parts are caused to reflow for fixation. The term “reflow” refers to a sequential process including pre-heating a substrate on which electronic parts have been placed and heating the substrate at a temperature higher than the melting temperature of the solder paste, to thereby join the parts.

Recently, in order to keep pace with the trend for down-scaling electronic products, fine-pitch electronic parts are required. For example, 0.3-mm-pitch QFP (Quad Flat Package) type LSIs and CSPs (Chip Size Package) are employed. Thus, a solder paste having a printability suited for providing fine pitch is required. In order to satisfy such a demand of the industry, the average particle size of solder particles has been reduced. However, when the specific surface area of the solder particles increases due to reduction in particle size, reaction between the solder particles and a flux contained in the solder paste is accelerated, thereby disadvantageously deteriorating storage stability of the solder paste further.

The most plausible reason for deterioration in storage stability of solder paste is that solder powder reacts preferentially with flux during storage, to thereby accelerate oxidation of the solder powder, and an active agent contained in the flux is consumed, to thereby reduce the activity of the flux and simultaneously elevate the viscosity of the solder paste due to reaction products. When these phenomena occur, disadvantageously, the solder paste cannot maintain suitable printing performance during application thereof and cannot dissolve during a reflow process.

In order to enhance storage stability of solder paste, efforts have been conventionally made for protecting the surface of solder particles, in order to reduce reactivity of metallic particles.

For example, Japanese Patent Publication (kokoku) No. 5-26598 discloses such a method involving coating solder powder with glycerin, and Japanese Patent Application Laid-Open (kokai) No. 1-113197 discloses such a method involving coating solder powder with a coating material which is insoluble or is difficult to dissolve in a solvent for preparing solder paste. As disclosed in the latter, examples of preferred coating materials include silicone oil, silicone-based polymers, fluorosilicone oil, fluorosilicone resin, and fluorohydrocarbon-based polymers.

In addition, Japanese Patent Application Laid-Open (kokai) Nos. 3-184698 and 4-251691 disclose such a method involving coating solder powder with a resin predominantly containing a rosin which is incompatible with a flux at ambient temperature but which is compatible with the flux at a soldering temperature.

When the aforementioned methods are employed, coating of solder powder with a comparatively large amount of coating material can effectively prevent oxidation of the solder powder. However, such a large amount of coating material is disadvantageous during a reflow process of a solder paste, and may produce a large amount of solder balls. In addition, in the aforementioned method, solder powder is coated only physically, and the coating strength may be very weak. Thus, such a coating layer is possibly removed from the solder powder during a kneading step for preparing solder paste or during use thereof; i.e., during transportation or printing. The aforementioned rosin-base coating material per se contains a large amount of reactive organic acid. Thus, complete protection of the powder by the rosin-based coating material is difficult to attain.

In addition to the aforementioned methods, several methods for enhancing the storage stability have been proposed. For example, there have been proposed a method involving adding a phenolic, phosphite-based or sulfur-containing anti-oxidizing agent serving as an active agent of a flux for soldering (Japanese Patent Publication (kokoku) No. 59-22632 and Japanese Patent Application Laid-Open (kokai) No. 3-124092); a method involving adding, in an amount of 1-30 wt. %, at least one species of anti-oxidant having, in its molecule, at least one phenol skeleton to which a tertiary butyl group is attached (Japanese Patent Application Laid-Open (kokai) No. 5-185283); and a method involving employment of a specific surfactant (Japanese Patent Application Laid-Open (kokai) No. 2-147194).

Recent environmental issues encourage use of a Pb-free solder paste, and accordingly, development of such pastes is under way. Among such pastes, Sn—Zn-based solder paste particularly attracts attention as a promising solder paste, because the paste is advantageous in terms of resource availability and costs, and can undergo reflow at a temperature approximately equal to the reflow temperature of Sn—Pb-based solder, to thereby prolong the life of mounted electronic parts and attain mounting of a variety types of parts. However, Sn—Zn-based solder paste has a storage stability much inferior to that of a typical Pb-based solder paste, and the viscosity thereof increases as time elapses through oxidation of Zn contained in solder powder and through reaction between Zn and a flux. Particularly, Zn reacts, at ambient temperature, with a halogen compound contained in the flux, thereby deteriorating storage stability of the solder paste. In addition, it has been proven that reaction of a halogen compound contained in a flux with Zn contained in solder powder yields a small amount of hydrogen gas, and that the thus-generated hydrogen gas is occluded in solder fillets even after completion of joining of parts, thereby detrimentally affecting reliability.

### SUMMARY OF THE INVENTION

In view of the foregoing, an object of the present invention is to provide a solder paste having excellent storage stability. Another object of the invention is to provide a reliable method for soldering by use of the solder paste. Still another object of the invention is to provide a joint produced through the method.

The present inventors have carried out extensive studies so as to solve the aforementioned problems, and have accomplished the present invention. Accordingly, the present invention provides:

[1] a solder paste containing a halogen compound, characterized in that the halide ion concentration in one gram of flux is 3000 ppm or less as converted to chloride ion concentration;

[2] a solder paste as described in [1], wherein the halide ion is a bromide ion;

[3] a solder paste as described in [1] or [2], wherein solder powder contains Zn;

[4] a method for soldering a circuit board, characterized by comprising applying a solder paste as described in [1] or [2] onto the circuit board and causing the applied solder paste to reflow;

[5] a method for soldering a circuit board, characterized by comprising applying a solder paste which contains Zn as solder powder as described in [1] or [2] onto the circuit board and causing the applied solder paste to reflow;

[6] a joint produced through a method for soldering a circuit board, wherein the method comprises

applying a solder paste as described in [1] or [2] onto the circuit board; and,

causing the applied solder paste to reflow; and,

[7] a joint produced through a method for soldering a circuit board, wherein the method comprises

applying a solder paste which contains Zn as solder powder as described in [1] or [2] onto the circuit board; and,

causing the applied solder paste to reflow.

### DETAILED DESCRIPTION OF THE INVENTION

The flux contained in solder paste comprises a resin component which is rosin or synthetic resin; a halogen compound and/or an organic acid component serving as active agents; a solvent; and a thixotropic agent. Among these components, the halogen compound and/or the organic acid component serving as active agents are components effective for removing a surface oxide of metallic solder during a reflow process, to thereby attain a favorable bonding state. Although these active agents enhance the power of removing surface oxide, these agents react with solder powder during preparation and storage of solder paste, thereby deteriorating the solder paste. Particularly, the halogen compound, which is a highly effective active agent, deteriorates solder paste to a considerable degree.

The present inventors have investigated reaction of solder powder and an active agent contained in solder paste, and have found that deterioration of the solder paste can be prevented and storage stability of the solder paste can be enhanced by controlling the halide ion concentration in one gram of flux for solder paste to 3000 ppm or less as converted to the chloride ion concentration, preferably 1000 ppm or less, more preferably 500 ppm or less, most preferably 300 ppm or less, so as to suppress reaction between the solder powder and the active agent.

No clear reason why halide ions adversely affect the storage stability of solder paste has been elucidated. However, it can be assumed that the oxidizing power of the halogen compound incorporated into a flux is reinforced in the presence of halide ions, to thereby accelerate reaction thereof with solder metal.

The halide ion concentration as converted to the chloride ion concentration can be obtained in the following manner:

weighing the solder paste to be analyzed; subjecting the paste to extraction by use of an organic solvent-water system;

quantitatively determining, through ion chromatography, the halide ion concentration in the aqueous layer obtained through extraction;

and reducing the measured value to the chloride ion concentration in one gram of flux. The term “halide ion concentration as converted to the chloride ion concentration” refers to a concentration obtained by reducing the halide ion concentration to the chloride ion concentration. For example, when a bromine compound is used as an active agent, the reduced concentration is derived by multiplying the determined bromide ion concentration in the solder paste (μg/g) by 35.453/79.904 (atomic weight of Cl/atomic weight of Br). Also, when an iodine compound is used as an active agent, the reduced concentration is derived by multiplying the determined iodide ion concentration (μg/g) by 35.453/126.9045 (atomic weight of Cl/atomic weight of I).

Regarding the organic solvent employed for extraction, there can be used a halide-ion-free solvent which is conventionally employed in a process such as organic synthesis; does not react with flux; and is not soluble in water. Examples include chloroform, methylene chloride, toluene, xylene, benzene, diethyl ether, and petroleum ether. Of these, chloroform, toluene, xylene, diethyl ether, and petroleum ether are preferably used, in view of solving power to flux and ease of extraction operation. Halide-ion-free water can be used as water for extraction. For example, ultra-pure water is most preferably used. The aforementioned measurement of the halide ion concentration by use of an organic solvent-water extraction system is applicable to solder paste containing a flux; i.e., water-soluble flux or water-insoluble flux.

In the present invention, the halide ion concentration in a flux contained in solder paste is controlled to 3000 ppm or less as converted to the chloride ion concentration. For example, in the case in which organic base hydrohalogenated acid salts—preferably used as active agent—such as an amine hydrohalogenated acid salt; e.g., isopropylamine hydrobromide, butylamine hydrochloride, or cyclohexylamine hydrobromide and a 1,3-diphenylguanidine hydrohalogenated salt are employed, the halogens contained in such compounds are present in the form of halide ions. Unless another halogen compound is used, the above compounds may be added such that the halide ion concentration is 3000 ppm or less as converted to the chloride ion concentration.

Regarding the halogen compound, halogen compounds incorporated into a typical flux for solder may be used. However, in order to further improve solderability and wettability of solder paste, a halogen compound which is chemically stable in the solder paste during storage and is activated through decomposition at reflow temperature is preferably used such that the halide ion concentration is 3000 ppm or less as converted to the chloride ion concentration. A particularly preferred halogen compound is an organic bromine compound.

Examples of the organic bromine compounds having such performance include a brominated benzyl compound which contains a substituent having an alkyl chain with 10 or more carbon atoms, and a polybrominated fatty acid compound or a polybrominated alicyclic compound with 10 or more carbon atoms containing four or more bromine atoms in the molecule thereof. These bromine compounds may be used in combination.

Specific examples of the benzyl bromide compounds which contain a substituent having an alkyl chain with 10 or more carbon atoms include compounds such as 4-stearoyloxybenzyl bromide, 4-stearyloxybenzyl bromide, 4-stearylbenzyl bromide, 4-bromomethylbenzyl stearate, 4-stearoylaminobenzyl bromide, and 2,4-bisbromomethylbenzyl stearate. Moreover, mention may be given of 4-palmitoyloxybenzyl bromide, 4-myristoyloxybenzyl bromide, 4-lauroyloxybenzyl bromide, and 4-undecanoyloxybenzyl bromide.

The polybrominated compound is a compound where four or more bromine atoms are bonded. The polybrominated compound may have a functional group such as a carboxyl group, an ester group, an alcohol group, an ether group, or a ketone group.

Specific examples of these compounds include 9,10,12,13,15,16-hexabromostearic acid, methyl 9,10,12,13,15,16-hexabromostearate, ethyl 9,10,12,13,15,16-hexabromostearate, 9,10,12,13-tetrabromostearic acid, methyl 9,10,12,13-tetrabromostearate, ethyl 9,10,12,13-tetrabromostearate, 9,10,12,13,15,16-hexabromostearyl alcohol, 9,10,12,13-tetrabromostearyl alcohol, and 1,2,5,6,9,10-hexabromocyclododecane. Of these, hexabromostearic acid and hexabromocyclododecane are particularly preferred.

Examples of organic brominated compounds other than the aforementioned compounds include bromides such as 1-bromo-2-butanol, 1-bromo-2-propanol, 3-bromo-1-propanol, 3-bromo-1,2-propanediol, 1,4-dibromo-2-butanol, 1,3-dibromo-2-propanol, 2,3-dibromo-1-propanol, 1,4-dibromo-2,3-butanediol, 2,3-dibromo-2-butene-1,4-diol, 1-bromo-3-methyl-1-butene, 1,4-dibromobutene, 1-bromo-1-propene, 2,3-dibromopropene, ethyl bromoacetate, ethyl α-bromocaprylate, ethyl α-bromopropionate, ethyl β-bromopropionate, ethyl α-bromoacetate, 2,3-dibromosuccinic acid, 2-bromosuccinic acid, 2,2- bromoadipic acid, 2,4-dibromoacetophenone, 1,1-dibromotetrachloroethane, 1,2-dibromo-1-phenylethane, and 1,2- dibromostyrene. However, the present invention is by no means limited to these examples. Alternatively, corresponding organic halogenated compounds containing chlorine or iodine instead of bromine may be used.

These halogen compounds are added to a solder paste such that the total amount halide ions in one gram of flux is 3000 ppm or less as converted to the chloride ion concentration. These halogen compounds may be used singly or in combination of two or more species. Moreover, an organic halogen compound and an organic base hydrohalogenated acid salt may be used in combination.

Examples of the organic acid component according to the present invention include conventionally known acids such as succinic acid, phthalic acid, stearic acid, and sebacic acid. Derivatives of such acids—compounds which generate an organic acid when the derivatives reach the reflow temperature—are preferably used. Examples of such derivatives include various aliphatic carboxylic acid esters, aromatic carboxylic acid esters, aliphatic sulfonic acid esters, and aromatic sulfonic acid esters.

The alcoholic fragment of these esters is preferably an alkyl group or an aryl group, with a t-butyl group, an isopropyl group, and an isobutyl group being particularly preferred, in view of high decomposability. In addition, these esters may contain halogen atoms.

Specific examples include n-propyl p-toluenesulfonate, isopropyl p-toluenesulfonate, isobutyl p-toluenesulfonate, n-butyl p-toluenesulfonate, n-propyl benzenesulfonate, isopropyl benzenesulfonate, isobutyl benzenesulfonate, n-propyl salicylate, isopropyl salicylate, isobutyl salicylate, n-butyl salicylate, isopropyl 4-nitrobenzoate, t-butyl 4-nitrobenzoate, t-butyl methacrylate, t-butyl acrylate, t-butyl malonate, and t-butyl bromoacetate. Of these, n-propyl p-toluenesulfonate, isobutyl salicylate, and t-butyl bromoacetate are particularly preferred. The amount of the organic acid component to be added ranges from 0.01 to 20 mass %, preferably from 0.05 to 5 mass %, based on the total amount of flux.

The aforementioned decomposable organic acid ester exhibits low decomposability even at the reflow temperature when it is present alone. Addition of a small amount of an ester decomposition catalyst effectively accelerates decomposition of the organic acid ester. An ester decomposition catalyst is not particularly limited, so long as it accelerates decomposition of a decomposable organic acid ester at the reflow temperature with resultant acceleration of acid generation. Among such catalysts, a hydrohalogenated acid salt of an organic base is effective.

A known resin which has conventionally been blended into flux may be blended into the solder paste of the present invention. Examples of such resins include a natural rosin, a disproportionated rosin, a polymerized rosin, a modified rosin, and synthetic resins such as polyester, polyurethane, and an acrylic resin.

The present invention may employ any solvents used in conventional fluxes and solder pastes; specifically, alcohols, ethers, esters, and aromatic solvents. Examples of such solvents include benzyl alcohol, butanol, ethyl cellosolve, butyl cellosolve, butyl carbitol, diethylene glycol hexylether, propylene glycol monophenyl ether, dioctyl phthalate, and xylene. These solvents may be used singly or in combination.

A thixotropic agent to be added in order to improve printability may be an inorganic substance, such as fine silica particles or kaolin particles, or an organic substance, such as hydrogenated castor oil or an amide compound.

The storage stability of the solder paste of the present invention can be further enhanced by employing, in combination, a reducing agent serving as a stabilizer.

Reducing agents which serve as typical anti-oxidants of resin and can be dissolved in a solvent are used as the above reducing agent. Examples include phenolic compounds, phosphorus-containing compounds, sulfur-containing compounds, tocopherol and its derivatives, and L-ascorbic acid and its derivatives.

Specific examples of the phenolic compounds include hydroquinone, catechol, 2,6-di-t-butyl-p-cresol, butylhydroxyanisole, and 2,2′-methylenebis(4-methyl-6-t-butylphenol).

Examples of the phosphorus-containing compounds include triphenyl phosphate, trioctadecyl phosphate, and tridecyl phosphite.

Examples of the sulfur-containing compounds include dilauryl 3,3′-thiodipropionate, distearyl 3,3′-thiodipropionate, and dimyristyl 3,3′-thiodipropionate.

Regarding tocopherol and its derivatives and L-ascorbic acid and its derivatives, compounds which have reducing power and can be dissolved in a solvent; e.g., esters thereof, can be employed. Particularly, when tocopherol or its derivative and L-ascorbic acid or its derivative are employed in combination, excellent storage stability can be attained. The two components are blended in a proportion by weight of 0.5:1 to 1:0.5, particularly preferably approximately 1:1.

Specific examples of the L-ascorbic acid derivatives include ascorbic acid-2-phosphate, ascorbic acid-2-sulfate, ascorbic acid-2-glucoside, ascorbic acid-2,6-dibutyrate, ascorbic acid-2,6-distearate, ascorbic acid-2,6-dimyristate, ascorbic acid-6-palmitate, ascorbic acid-6-stearate, ascorbic acid-6-myristate, ascorbic acid-2,3,5,6-tetrapalmitate, ascorbic acid-2,3,5,6-tetramyristate, ascorbic acid-2,3,5,6-tetrastearate, ascorbic acid-2-glucoside-6-palmitate, ascorbic acid-2-glucoside-6-myristate, ascorbic acid-2-glucoside-6-stearate, ascorbic acid-5,6-benzylidene, ascorbic acid-5,6-propylidene, ascorbic acid-2-phosphate-5,6-benzylidene, and ascorbic acid-2-phosphate-5,6-propylidene. Specific examples of the tocopherol derivatives include tocol, tocophenol acetate, tocopherol phosphate, tocopherol sorbate, and tocopherol nicotinate.

These reducing agents may be used singly or in combination. The amount of the reducing agent added to a solder paste may be an amount which assures sufficient storage stability of the paste. In general, the amount is 0.005-20 mass % based on the total amount of the flux, more preferably 0.01-10 mass %. When the amount is too low, no stabilizing effect can be attained, whereas when the amount is in excess of 20 mass %, enhancement of the effect commensurate with the high-concentration addition cannot be attained. Both cases are disadvantageous.

Flux for use in the solder paste of the present invention comprises, with respect to the total amount of flux; a resin component 20-60 mass %; a thixotropic agent 0.04-20 mass %; an organic acid component 0.01-20 mass %; an halogen compound (amount to attain the aforementioned halide ion concentration); a reducing agent 0.005-20 mass %; and the balance solvent and other substances. For example, the thus-prepared flux (14-8 mass % to the total amount of solder paste) and a solder powder (86-92 mass %) are mixed, thereby yielding the solder paste of the present invention. In this case, a halide compound must be added in such an amount that the halide ion concentration in the flux after kneading the solder paste is controlled to 3000 ppm or less as converted to the chloride concentration.

During blending and kneading these components, the water content of the solder paste is preferably controlled to 0.5 mass % or lower, more preferably 0.3 mass % or lower by adjusting the water content of the flux and the humidity of the operational atmosphere. When the paste has a water content in excess of 0.5 mass %, dissociation of the halide compound is accelerated, and released halide ions disadvantageously react with solder alloy powder. In addition, the pH of the solder paste is preferably controlled to 4-9, more preferably 6-8, so as to suppress reaction of the solder powder and the flux. A preferred pH adjusting agent is any of amine compounds, such as alkanolamines, aliphatic primary through tertiary amines, aliphatic unsaturated amines, alicyclic amines, and aromatic amines.

Specific examples of these amine compounds include ethanolamine, butylamine, aminopropanol, polyoxyethylene oleylamine, polyoxyethylene laurylamine, polyoxyethylene stearylamine, diethylamine, triethylamine, methoxypropylamine, dimethylaminopropylamine, dibutylaminopropylamine, ethylhexylamine, ethoxypropylamine, ethylhexyloxypropylamine, bispropylamine, isopropylamine, and diisopropylamine.

The amine compound is added preferably in an amount of 0.05-20 mass % to the total amount of flux contained in the solder paste. When the amount is less than 0.05 mass %, the amine compound fails to sufficiently serve as a pH adjusting agent. When the amount is in excess of 20 mass %, the pH of the solder paste usually exceeds 9; i.e., the pH shifts to the alkaline side. As a result, the solder paste tends to become hygroscopic.

In order to prevent corrosion of copper in circuit lines, any of azoles may be added to the flux. Examples of such azoles include benzotriazole, benzimidazole, and tolyltriazole. Such an anticorrosion agent is added preferably in an amount of 0.05-20 mass % to the total amount of flux.

The solder powder to be employed in the solder paste of the present invention may have a conventionally known composition in terms of metallic elements. However, a solder powder containing Zn—a readily oxidizable element—is preferably used. Examples of such solder include Sn—Zn-based solder, Sn—Ag—Zn-based solder, Sn—Bi—Sb—Zn-based solder, Sn—Bi—Cu—Zn-based solder, Sn—Ag—Sb—Zn-based solder, Sn—Ag—Cu—Zn-based solder, and Sn—Zn—Bi-based solder.

A typical example of the aforementioned solder is a eutectic solder comprising 91 mass % Sn and 9 mass % Zn (hereinafter represented by 91Sn/9Zn). Other than this solder, further examples include 95.5Sn/3.5Ag/1Zn, 51Sn/45Bi/3Sb/1Zn, 84Sn/10Bi/5Sb/1Zn, 88.2Sn/10Bi/0.8Cu/1Zn, 88Sn/4Ag/7Sb/1Zn, 97Sn/1Ag/1Sb/1Zn, 91.2Sn/2Ag/0.8Cu/6Zn, 89Sn/8Zn/3Bi, 86Sn/8Zn/6Bi, and 89.1Sn/2Ag/0.9Cu/8Zn. These solder powders may be used, as the solder powder of the present invention, in combination of two or more different species.

The solder paste of the present invention is preferably used for joining a substrate such as a printed wiring board and electronic parts, to thereby produce a joined product. According to a method for using the solder paste of the present invention and to a method for producing electronic part-joined products, for example, the solder paste is applied, through a method such as printing, to a portion to be soldered; electronic parts are placed thereon; and the assembly is heated, to thereby melt solder particles, and then solidified, to thereby join the electronic parts to the substrate.

A typical method for joining a substrate and electronic parts (i.e., a mounting method) is a surface mounting technology (SMT). This mounting method involves applying a solder paste to a substrate; for example, on a desired portion on a wiring board, through printing; subsequently placing electronic parts such as chip parts and QFP on the applied solder paste; and soldering the entirety by means of a reflow heat source. Examples of such a reflow heat source include a hot air chamber, an infrared radiation chamber, a vapor phase condensation soldering apparatus, and a light-beam soldering apparatus.

The reflow process of the present invention depends on the composition of a solder alloy. In the case of the Sn—Zn-based solder alloys, such as 91Sn/9Zn, 89Sn/8Zn/3Bi, and 86Sn/8Zn/6Bi, reflowing is performed preferably in two steps; namely, preheating and reflow. Regarding conditions, the preheating temperature is 130-180° C., preferably 130-150° C. The preheating time is 60-120 seconds, preferably 60-90 seconds. The reflow temperature is 210-230° C., preferably 210-220° C. The reflow time is 30-60 seconds, preferably 30-40 seconds. In the case of solder alloys of other types, the reflow temperature is a melting point of a solder alloy to be used plus 20-50° C., preferably a melting point plus 20-30° C., whereas the preheating temperature, the preheating time, and the reflow time may fall within the aforementioned corresponding ranges.

When the solder paste of the present invention is used, the aforementioned reflow process can be carried out both in a nitrogen atmosphere and in air. When the nitrogen atmosphere is chosen, the oxygen concentration of the atmosphere is controlled to 5 vol % or less, preferably 0.5 vol % or less, to thereby enhance wettability of solder to a substrate such as a wiring board as compared with a reflow process in air. In addition, generation of solder balls are suppressed, to thereby attain smooth treatment.

Subsequently, the reflowed substrate is cooled to complete surface mounting. In this mounting method, joining may be effected on both sides of a substrate such as a printed wiring board (onto which electronic parts are to be mounted) for producing electronic-parts-mounted products. No particular limitation is imposed on the electronic parts to which the solder paste of the present invention can be applied. Examples of the electronic parts include LSIs, resistors, capacitors, transducers, inductors, filters, oscillator, and vibrators.

Alternatively, mounting is carried out by use of the solder paste of the present invention through the SMT (surface mounting technology) on a circuit substrate which is prepared in the following manner: forming in advance adhesive coating film exclusively on a predetermined surface portion of a substrate (e.g., metallic wiring of a printed wiring board) by means of chemical reaction; depositing solder powder on the adhesive coating film; applying flux thereon; and reflowing by heating to the melting temperature of the solder, to form solder bumps on the circuit substrate (Japanese Patent Application Laid-Open (kokai) No. 7-7244). In this case, excellent solderability can be attained.

By using the solder paste of the present invention, fine-pitch mounting of electronic parts (e.g., fine-pitch mounted wiring boards and variety of electronic parts) can be attained by means of a Pb-free, less-environmental-contaminant solder alloy. Accordingly, a wiring board which can prolong the service life of electronic parts can be provided.

### BEST MODES FOR CARRYING OUT THE INVENTION

The present invention will next be described in more detail by way of examples, which should not be construed as limiting the invention thereto.

[Test Methods]

(1) Measurement of Halide Ion Concentration

Chloroform (5 ml) was added to a solder paste (1 g), and the mixture was stirred to thereby dissolve a flux component. Subsequently, ultra-pure water (10 ml) was added to the stirred mixture so as to take up halide ions into water. The aqueous layer was analyzed through ion chromatography.

Apparatus employed: YOKOGAWA IC-100

Column for separation: SAM3-125

Filler: Hydrophilic low-exchange-capacitance, strong-ion-exchange resin

Particle size: 10 μm

Exchange capacitance: 60 μeq/ml

Eluent and flow rate: 4 mM Na₂CO₃/4 mM NaHCO₃, 2 ml/minute

Remover and flow rate: 0.05 M n-dodecylbenzenesulfonic acid, 2 ml/minute

Temperature: 40° C.

Sample volume: 100 μl

(2) Viscosity Measurement

Viscosity of solder paste samples (10 rpm) was measured immediately after preparation and after 7-day storage at 25° C., by use of a spiral viscometer (type PCU-205, Marukomu).

(3) Observation of Voids (Checking Reliability of Bonding)

To each copper plate (60 mm×60 mm), 6 patterns (diameter 6 mm) were formed through printing by use of a metal mask (thickness 150μ). Each of the resultant solder-printed samples was subjected to a reflow process under atmospheric conditions, and the resultant sample was cut by means of a cutter. The cross-section of solder portions was observed under a microscope, to thereby investigate void generation. The number of voids of 10 μm or larger was counted in 6 patterns. When the average number per pattern was 2 or more, the sample was indicated as “test not passed.”

### EXAMPLES 1 TO 9 AND COMPARATIVE EXAMPLES 1 to 3

<Production of Flux and Solder Paste>

Each of flux samples was prepared by mixing the following components: polymerized rosin (17.5 mass %) and disproportionated rosin (27.5 mass %) serving as resin components; hydrogenated castor oil (7 mass %) serving as a thixotropic agent; diphenylguanidine hydrobromide or cyclohexylamine hydrobromide serving as an organic base hydrohalogenated salt; hexabromocyclododecane, 2,3-dibromo-2-butene-1,4-diol, or 4-stearoyloxybenzyl bromide serving as a halogen compound; isobutyl salicylate or n-propyl p-toluenesulfonate serving as an organic acid component; the amounts of these three components being shown in Table 1, triethanolamine (2 mass %) serving as a pH-adjusting agent; hydroquinone (0.3 mass %) serving as a reducing agent; benzimidazole (1 mass %) serving as an anti-corrosive agent; and diethylene glycol mono-2-ethylhexyl ether (balance) serving as a solvent, to thereby attain the total amount of 100 mass %.

TABLE 1-1

| | Organic halogen | Organic base | Organic acid |
|---|---|---|---|
| Ex. | compound | hydrohalogenate | component |
| 1 | none | cyclohexylamine | isobutyl |
| | | hydrobromide | salicylate |
| | | 1.2 mass % | 0.5 mass % |
| 2 | 2,3-dibromo-2- | cyclohexylamine | n-propyl p- |
| | butene-1,4-diol | hydrobromide | toluenesulfonate |
| | 3.5 mass % | 0.3 mass % | 0.5 mass % |
| 3 | 2,3-dibromo-2- | none | n-propyl p- |
| | butene-1,4-diol | | toluenesulfonate |
| | 3.5 mass % | | 0.5 mass % |
| 4 | 4-stearoyl- | diphenyl- | isobutyl |
| | oxybenzyl | guanidine | salicylate |
| | bromide 3.5 | hydrobromide | 0.5 mass % |
| | mass % | 0.3 mass % | |
| 5 | 4-stearoyl- | none | isobutyl |
| | oxybenzyl | | salicylate |
| | bromide 3.5 | | 0.5 mass % |
| | mass % | | |
| 6 | hexabromo- | diphenyl- | isobutyl |
| | cyclododecane | guanidine | salicylate |
| | 3.5 mass % | hydrobromide | 0.5 mass % |
| | | 0.1 mass % | |
| 7 | hexabromo- | none | isobutyl |
| | cyclododecane | | salicylate |
| | 3.5 mass % | 0.5 mass % | |
| 8 | tetrabromo- | diphenyl- | n-propyl p- |
| | stearic acid | guanidine | toluenesulfonate |
| | 2.0 mass % | hydrobromide | 0.5 mass % |
| | hexabromo- | 0.1 mass % | |
| | cyclododecane | | |
| | 1.5 mass % | | |
| 9 | tetrabromo- | none | n-propyl p- |
| | stearic acid | | toluenesulfonate |
| | 2.0 mass % | | 0.5 mass % |
| | hexabromo- | | |
| | cyclododecane | | |
| | 1.5 mass % | | |

TABLE 1-2

| | Organic halogen | Organic base | Organic acid |
|---|---|---|---|
| Comp. Ex. | compound | hydrohalogenate | component |
| 1 | none | cyclohexylamine | isobutyl |
| | | hydrobromide | salicylate |
| | | 5.0 mass % | 0.5 mass % |
| 2 | 2,3-dibromo-2- | diphenyl- | isobutyl |
| | butene-1,4-diol | guanidine | salicylate |
| | 3.5 mass % | hydrobromide | 0.5 mass % |
| | | 3.0 mass % | |
| 3 | 4-stearoyl- | cyclohexylamine | isobutyl |
| | oxybenzyl | hydrobromide | salicylate |
| | bromide 3.5 | 2.0 mass % | 0.5 mass % |
| | mass % | | |

A powder (89 mass %) of Pb-free solder, 89Sn/8Zn/3Bi, was added to each flux (11 mass %), and the mixture was kneaded by means of a planetary mill, to thereby produce a solder paste (3 kg).

<Production of Electronic-parts-joined Products>

Mounting of electronic parts was performed through SMT. Each of solder pastes (Examples 1 to 9 and Comparative Examples 1 to 3) was applied to one sheet of a circuit board through printing, and an LSI, a chip resistor, and a chip capacitor were placed on the solder paste. Then, the resultant assembly was heated by a reflow heat source, to thereby effect soldering. The reflow heat source was supplied from a hot air chamber.

The reflow process was performed under the following conditions: pre-heating temperature (130° C.), pre-heating time (80 seconds), reflow peak temperature (220° C.), and reflow time at 200° C. or higher (50 seconds).

The characteristics of the thus-produced printed wiring boards and solder pastes used for producing the wiring boards were evaluated through the aforementioned measurement methods. The results are shown in Table 2. In Table 2, the halide ion concentration is reduced to chloride ion concentration.

TABLE 2

| | Halide ion | | | | |
|---|---|---|---|---|---|
| | concentration | | | Viscosity | |
| | (ppm) | | Void | (Pa · s) | |
| Ex. | Initial | day 7 | generation | initial | day 7 |
| 1 | 2400 | 2450 | O | 215 | 240 |
| 2 | 650 | 850 | O | 201 | 220 |
| 3 | 180 | 200 | O | 210 | 211 |
| 4 | 400 | 500 | O | 189 | 206 |
| 5 | 150 | 230 | O | 205 | 210 |
| 6 | 150 | 250 | O | 199 | 213 |
| 7 | 150 | 200 | O | 195 | 208 |
| 8 | 150 | 200 | O | 198 | 208 |
| 9 | 150 | 200 | O | 195 | 206 |
| Comp. Ex. | | | | | |
| 1 | 9900 | 9950 | X | not | not |
| | | | | measurable | measurable |
| 2 | 4500 | 6150 | X | 372 | not |
| | | | | | measurable |
| 3 | 4000 | 7950 | X | 329 | not |
| | | | | | measurable |

O: Test passed X: Test not passed

In addition, Pb-free solder powders, 91Sn/9Zn and 86Sn/8Zn/6Bi, were subjected to similar tests. The results are almost equivalent to the aforementioned results.

The solder alloys of Examples 1 to 9 were compared with a conventional Sn—Pb-based alloy for preparing solder paste, in terms of alloy texture after a reflow process. The Sn—Pb-based alloy exhibited considerable coarsening of crystal grains under high-temperature conditions, whereas the Sn—Zn-based alloy according to the present invention exhibited a small tendency of grain coarsening. Accordingly, it has been confirmed that mechanical properties of solder and the service life of mounted wiring boards produced by use of the solder can be enhanced.

### Industrial Applicability

The solder paste of the present invention greatly suppresses reaction between solder alloy and flux, to thereby provide remarkably excellent storage stability. Particularly, the present invention greatly enhances the storage stability of Sn—Zn-based solder paste, which has conventionally been known to be low, and the effect of the invention can be confirmed.

In addition, the solder paste developed on the basis of the present invention can provide a method for soldering circuit boards, which method is highly reliable and suitable for producing fine-pitch mounted wiring boards and a variety of parts, and also can provide a joint produced through soldering.

1. A solder paste containing a halogen compound, characterized in that the halide ion concentration in one gram of flux is 3000 ppm or less as converted to chloride ion concentration.

2. A solder paste as described in claim 1, wherein the halide ion is a bromide ion.

3. A solder paste as described in claim 1 or 2, wherein solder powder contains Zn.

4. A method for soldering a circuit board, characterized by comprising applying a solder paste as described in claim 1 or 2 onto the circuit board and causing the applied solder paste to reflow.

5. A method for soldering a circuit board, characterized by comprising applying a solder paste which contains Zn as solder powder as described in claim 1 or 2 onto the circuit board and causing the applied solder paste to reflow.

6. A joint produced through a method for soldering a circuit board, wherein the method comprises
applying a solder paste as described in claim 1 or 2 onto the circuit board; and,
causing the applied solder paste to reflow.

7. A joint produced through a method for soldering a circuit board, wherein the method comprises
applying a solder paste which contains Zn as solder powder as described in claim 1 or 2 onto the circuit board; and,
causing the applied solder paste to reflow.
